(19) United States
(12) Patent Application Publication
(10) Pub. No.: US 2006/0242592 A1
(43) Pub. Date: Oct. 26, 2006

(54) INTERACTIVE EDUCATIONAL DEVICE

(76) Inventors: Edward Donald Edwards, Port Townsend, WA (US); Eric Guaglione, Durango, CO (US); Wayne Sabbak, Durango, CO (US); Randy Parker, Durango, CO (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/276,505

(22) Filed: Mar. 2, 2006

Related U.S. Application Data
(60) Provisional application No. 60/657,881, filed on Mar. 2, 2005.

(51) Int. Cl. G06F 9/00

(52) U.S. Cl. 715/764; 715/864; 715/810; 715/835

(57) ABSTRACT

Embodiments of the invention described herein include an interactive, educational device. The interactive, educational device includes a main body comprising a screen; computer readable medium comprising an application module that includes a global loader, a user interface, navigation and optionally, a splash screen and user data tracking; one or more content modules; a mechanism for projecting sound; a mechanism for playing content; and a mechanism for organizing content, wherein the content is related to an article proximal to the device.

### RELATED APPLICATION

The present application claims priority to U.S. Provisional Patent Application 60/657,881, which was filed on Mar. 2, 2005 and which is incorporated herein by reference.

Embodiments of the present invention relate to an interactive device for teaching a child or an adult how to interpret, repair, or use a device or object proximal to the child or adult.

### BACKGROUND

Going to a museum or zoo can be a frustrating experience to people who are not art historians or zoologists. Museum and zoo visitors view images that they do not really understand. They may be able to literally explain what they see but they have no context for understanding the significance of it. Zoos and museums may sell books providing additional information about animals or paintings, but the books are not very helpful when a parent is trying to answer questions regarding an animal or painting asked by his or her child. Some museums and historical sites provide audio devices for visitors to use as they pass through the museum or site. Typically, visitors pay a fee to use these devices. The audio devices are not interactive and provide only general information.

It is also frustrating for users of equipment such as computers to troubleshoot these machines. Users may try calling technical centers but it is frequently difficult for users to articulate a technical problem. Additionally, the call center employees frequently do not understand the language of the user and do not understand the computer either. Computer manuals can be very difficult to understand.

### SUMMARY

Embodiments of the invention described herein include an interactive, educational device. The interactive, educational device includes a main body comprising a screen; computer readable medium comprising an application module that includes a global loader, a user interface, navigation and optionally, a splash screen and user data tracking; and, one or more content modules; a mechanism for projecting sound; a mechanism for playing content; and a mechanism for organizing content, wherein the content is related to an article proximal to the device.

### DESCRIPTION OF DRAWINGS

FIG. 1 illustrates one embodiment of an interactive educational device of the invention.

FIG. 2 illustrates a flowchart embodiment of options provided by the device of FIG. 1.

FIG. 2A illustrates a schematic view of a file structure embodiment for use in embodiments of devices of the invention.

FIG. 2B illustrates a flowchart embodiment of operation of the interactive educational device.

FIG. 3 illustrates a screen embodiment for the educational device directed at children.

FIG. 4 illustrates an embodiment of an application flow diagram of the interactive educational device.

FIG. 5 illustrates a flowchart for movie loading for the interactive educational device.

FIG. 6 illustrates a navigational hierarchical view of screens of the interactive educational device.

FIG. 7 illustrates another embodiment of the interactive educational device.

FIG. 8 illustrates one other embodiment of the interactive educational device.

FIG. 9 illustrates an embodiment of a navigation flowchart of the interactive educational device.

### DEFINITIONS

“Module” as used herein refers to content prepared to teach or describe an idea or concept. A module is the top element of a hierarchy for any subject.

“Movie” as used herein refers to an element of a module that includes video images. A movie exposes, and teaches an idea or concept to a user.

“Threads” as used herein refer to connections that take a user from one movie to another and from a movie to a menu or vice versa or from one thread to another.

“Menus” as used herein refer to navigation tools for moving among threads and movies.

### DESCRIPTION

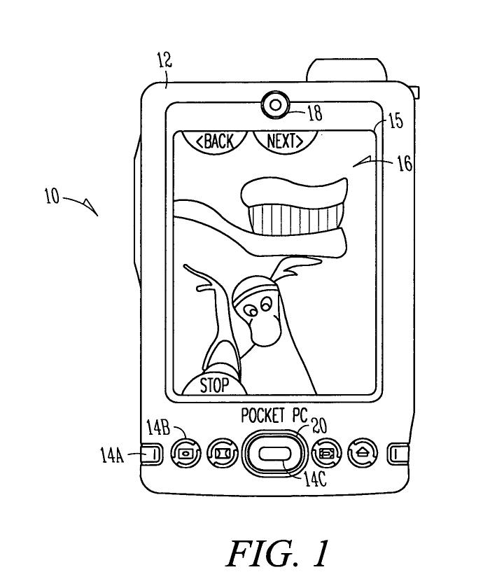

An interactive educational device embodiment of the invention described herein illustrated generally at 10 in FIG. 1, includes a hand held housing 12, having a planer face 15 with a plurality of keys 14a, 14b and 14c, at least one speaker 18, on/off switch 20 and a display window 16. The device also includes one or more of a card reader, or a CD or DVD reader, which are not shown. Some embodiments of the device also include a microprocessor, and a memory chip.

For some embodiments, each key 14a, 14b and 14c has a pressure sensitive switch, which is not shown, placed under it. Each pressure sensitive switch is electrically connected to a processor and activation of the pressure sensitive switch causes an electrical signal to be sent to the processor indicating selection of the key 14a-c corresponding to the pressure sensitive switch.

Other mechanisms of sensing selection of the key 14a-c may be used, such as providing the buttons 14a-c with touch-sensitive surfaces that send electrical signals to the processor when touched, or optically sensing selection of the buttons. These mechanisms are known to those skilled in the art.

For some embodiments, the device 10 also houses a battery, and processing circuitry of which the processor is a component. The processing circuitry includes, in addition to the processor, random access circuitry (RAM), read-only memory, a random number generator for some embodiments, and a voice synthesizer, for some embodiments, for driving the speaker 18. The read-only memory, which may be provided in the form of a Programmable Read-Only Memory (PROM), contains program instructions for operating the processor. Other configurations of the processing circuitry are possible, such as providing a separate read-only memory or removable memory for storing the data, or combining the functions of the processor and voice synthesizer into a single unit. The data may be provided in magnetically readable form on the cards inserted into a card reader. For other embodiments, smart cards are inserted into a smart card reader on the device 10. For other embodiments, RFID devices and/or bar code readers store content that is readable by the device 10 of the invention. For other embodiments, data is downloaded from the World Wide Web and is stored on a memory within the interactive educational device 10.

It is contemplated that the interactive device of the invention has, for some embodiments, functionality in addition to that described herein, such as cellular phone capability or wireless computer capability. With these embodiments, keys on the cellular phone or wireless computer capability activate screens such as those described herein.

Some embodiments of the interactive device 10 enable a child or an adult user to learn more about an article that is proximal to the child or adult. For instance, the interactive device may teach a child or adult how to interpret a painting that the child or adult user views in a museum. The interactive device may teach a user about an animal that the user views in a zoo. The interactive device may show a user how to repair an article that is proximal to the user. The article being repaired may be a computer, automobile, bicycle, and virtually any article proximal to a child or an adult. The interactive device may show a child or an adult how to cook a particular dish or make an article. The uses described herein are included as examples only and are not intended to limit the invention described herein. Those skilled in the art will appreciate that there are many uses for the interactive device of the invention.

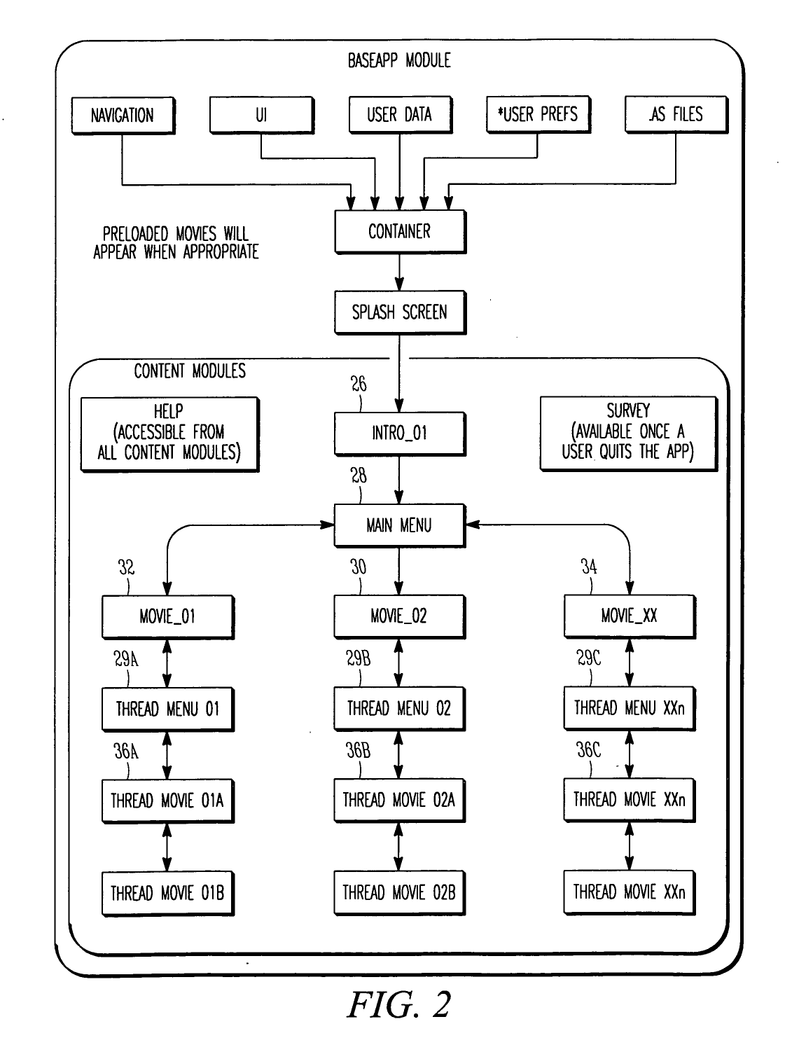

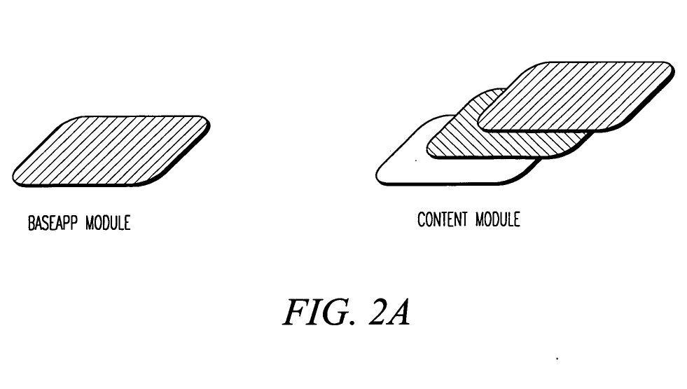

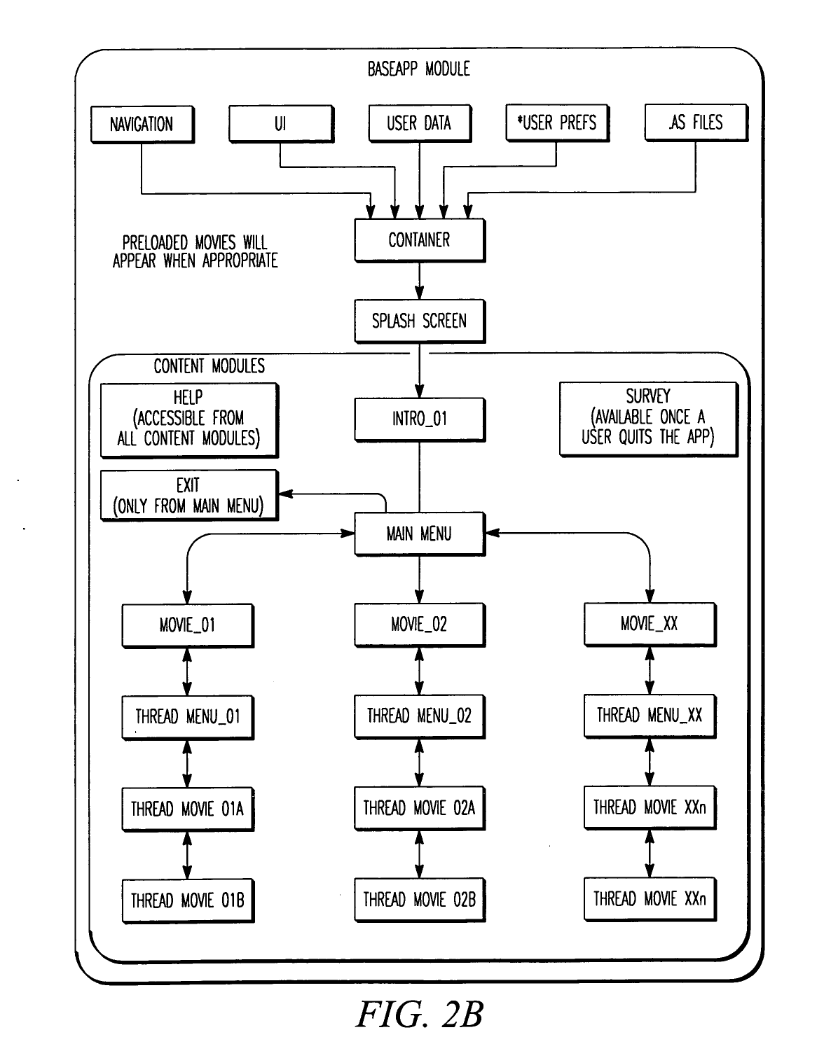

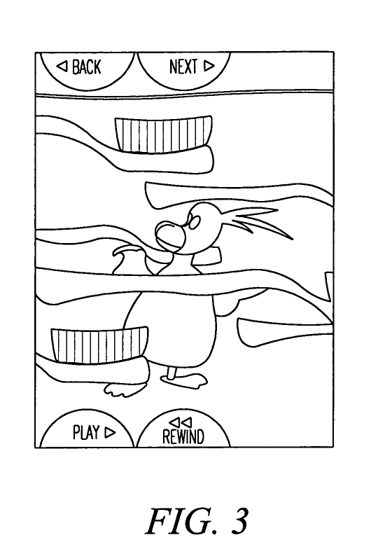

One flowchart illustrating process navigation using an embodiment of the interactive device of the invention is shown in FIG. 2. The process commences when the device 10 is turned on. In one embodiment, an initial screen displays a menu 26. For other embodiments, an initial screen displays one or more of indicia placed for promotion, design indicia, animation to engage a child, or other types of introductory screens. For other embodiments, the initial screen includes a catalogue of a collection of articles. For instance, in one embodiment, the device 10 includes a catalogue page listing each painting in a particular museum. The painting is identified by name, by an illustration of the painting or by both name and illustration.

In the museum embodiment, once the user selects the painting he or she is proximal to, on the interactive teaching device, the device 10 displays a screen 28 that includes a list of attributes related to the painting proximal to the user. In the instance of a painting in a museum, the list of attributes includes but is not limited to the painter, the year the painting was made; the type of art is represented by the painting, and so forth.

The user selects one of the items on the menu. If the user selects the “painter” attribute, the device displays a screen 32 showing a movie module that describes attributes of the painter using audio visual tools. If the user selects the “year the painting was made,” the device displays a movie module screen 30 describing historical highlights that occurred during and around the year the painting was made. The movie module allows the user to put the painting into a historical context. If the user selects the “type of art represented by the painting,” the device displays screen 34 with a movie module directed to the school of art represented by the painting, such as impressionist art and abstract art. Users may select only one of the items on the menu or may sequentially select all of the items.

Following each of the movie modules, a screen is displayed with at least one query, as shown at 29a, 29b and 29c in FIG. 2. In the museum embodiment, after the “type of art represented by the painting,” a screen appears with queries that require the user to look at the actual painting, proximal to the user more closely. For instance, one of the queries asks whether a particular color appears in the painting. Another query has the user focus on the texture of the painting. Another query has the user focus on the background of the painting. Each of the query pages requires the user to focus on the painting in order to formulate an answer. The purpose of the queries is to enable the user to obtain a greater comprehension and appreciation of the painting.

Once users have selected a query 29A, 29B and 29C, an answer module screen appears. In one embodiment, the answer module screen includes one or more possible answers, as shown at 36A, 36B and 36C in FIG. 2. An answer screen is shown for one question in 29C. However, it is understood that other answer screens are provided for each question on screens 29A, 29B and 29C. The user selects one of the possible answers. In one embodiment, a screen appears notifying the user that the answer selected is correct or incorrect. If the answer is incorrect, the user is directed back to the answer module screen to select another answer. If the answer is correct, the user is notified that the answer is correct. For some embodiments, after viewing the correct answer screen, the user is directed to another movie module providing additional information on the subject.

For some embodiments, the interactive tutorial stops at this level. For other embodiments, the user is provided with additional query screens, answer modules, and movie modules. When the user moves on to a new painting as he or she walks through a museum, the user returns to the menu page of the interactive teaching device and selects the new painting from a catalogue list. Another embodiment of a Flash application flow diagram is shown in FIG. 2B. With the process shown in FIG. 2B, users may exit the program from the main menu.

In another embodiment, the user navigates through content directed to the language of art, which is typically viewed in a classroom or at home, the meaning and interpretation of art, which is viewed in a museum, and the creation of art, which is viewed in a classroom or at home. For some embodiments, the language of art content is a module that covers the vocabulary of art, and principles, elements, foundations, and concepts of art. The language of art module also includes content for triggering the imagination and answering general questions regarding art, such as, “What is art?” The language of art module also includes content related to art styles, periods and cultural and historical relevance and choices and mistakes made by artists. For some embodiments, the language of art module describes museum etiquette. Objectives of the language of art module are sparking an interest for further learning of art and imparting a well founded vocabulary for the language of art, necessary for a meaningful museum visit and for more meaningful expression in the creation of one's own artwork.

The meaning and interpretation module content allows the user to experience the artwork, and brings the artist, his ideas, his faults, his revolutionary ways to life. The module content tells stories and evokes emotion in the user. The content enables the user to analyze a work of art and find meaning and context, such as time period, historical, sociological, cultural, or spiritual context. The module content provides a personal connection, imparts a deeper understanding to inspire discussion and social interaction, and provides creative play activities that enable the user to interact with the art. The module content also provides an assessment tool to measure interest, comprehension, and retention. The objectives for measuring success of the meaning and interpretation module include imparting a depth of understanding an artist's approaches and intentions; and provide tools to the user to critically look at a work of art and understand what matters most.

The third module, having creation content, enables a user to express onself through a visual language. The module content allows users to learn from, share with, and encourage peer experiences. The module content enables users to examine the power of art and how art shapes and reflects culture and history. The objectives of the creation module are to impart self expression through art; and enjoyment and appreciation as a result of understanding the language of art and the world of the artist. The objectives also include generating a desire for the continued learning of art in museums, the web and so forth.

Content for the interactive teaching device 10 is obtained, in one embodiment from a provider of the article proximal to the user. For instance, the user obtains content regarding paintings in a particular museum from the museum. In another embodiment, the museum directs the user to a content provider. For other embodiments, content is obtained from a manufacturer for a device being viewed by the user. It is understood that content may be prepared by any source.

For some embodiments, the interactive device includes a reader for reading content on a medium such as a DVD. For this embodiment, users obtain DVD or other tangible media for use in pre-selected sites. For instance, the user obtains a DVD for viewing all of the paintings at the Museum of Modem Art in New York City or obtains a DVD for viewing all of the animals at the London zoo. For other embodiments, content is downloaded from the Internet and is stored on a local drive component of the interactive teaching device.

The interactive teaching device is also capable of teaching a user about the components of an automobile engine and how to perform some maintenance tasks such as checking oil, changing oil and so forth. For one embodiment, the user uses the device to change oil in his or her automobile. The interactive educational device is capable of Internet access for this embodiment. The user downloads content for the particular auto and the particular task, changing oil, from the internet. As the user holds the device and views what is under the hood of the auto, the user compares his or her view to screens on the interactive device. The user views one or more movies that show the user how to change oil on the auto. This includes identifying components of the auto engine and showing the user how to manipulate the components to accomplish the task such of changing the oil.

The file structure for some embodiments of the device of the invention described herein includes a base application module and content modules, as shown in FIG. 2A The base application module includes navigation, a graphical user interface, user data tracking, application functionality, base application FLASH ActionScript functionality and branding. The content modules include streaming video, movies, narration and other specific content. The content modules include items such as a main menu, application help, all movie modules, one movie for each item, all thread SWF files, 1−n threads per movie module, audio files, narration and sound effects. With this arrangement of a base application module and content modules, it is possible to create multiple applications easily and to create new modules and integrate them into the baseApp module.

The baseApp module includes files such as a container, loader movie file, a navigation file, a splash screen file, a user data tracking file, ActionScript files, user preference files and preloader movie files.

Content module files include an intro movie file, intro thread modules, main content movie modules, a menu for thread modules, thread modules, unique location-based visual menu files, museum map files, user survey files and application help files.

The base application module and content modules include eight types of screens, which are splash screens, preloader screens, introduction screens, help screens, survey screens, main menu screens, screens for movies and threads and a map screen. The splash screen contains information concerning branding, and a brief introduction. The preloader screen displays while data is being pulled from a memory card. The introduction screen creates a theme for the presentation. The help screen includes help information in forms that include narration and animation. For some embodiments, help is available from every screen in the device except the splash screen. The survey screen queries users concerning whether they want to quit the application or continue. The survey screen sends the user back to a previous screen if the user does not choose to quit. The survey screen sends the user to an exit screen if they quit. Users also have an option to cancel. The map screen displays a map of a site visited, such as a museum or a zoo, or a layout of a device or a component of a device.

The main menu serves purposes of a main menu and, for some embodiments, a location reference. In an instance where embodiments of the device of the invention are used to provide information regarding paintings in a museum, the main menu includes a museum room selection option. For some embodiments, the user confirms that he or she is in the desired room by matching a particular feature of the room with an icon on the device that includes that feature. Also, artwork in the particular room is identifiable with artwork shown on the device.

Some embodiments of the invention inform a user of what rooms he or she has already visited by a visual indicator. The location tracking is performed by storing and retrieving variables in the movie. For some embodiments, the tracking is not associated with any type of physical location tracking system, such as WiFi.

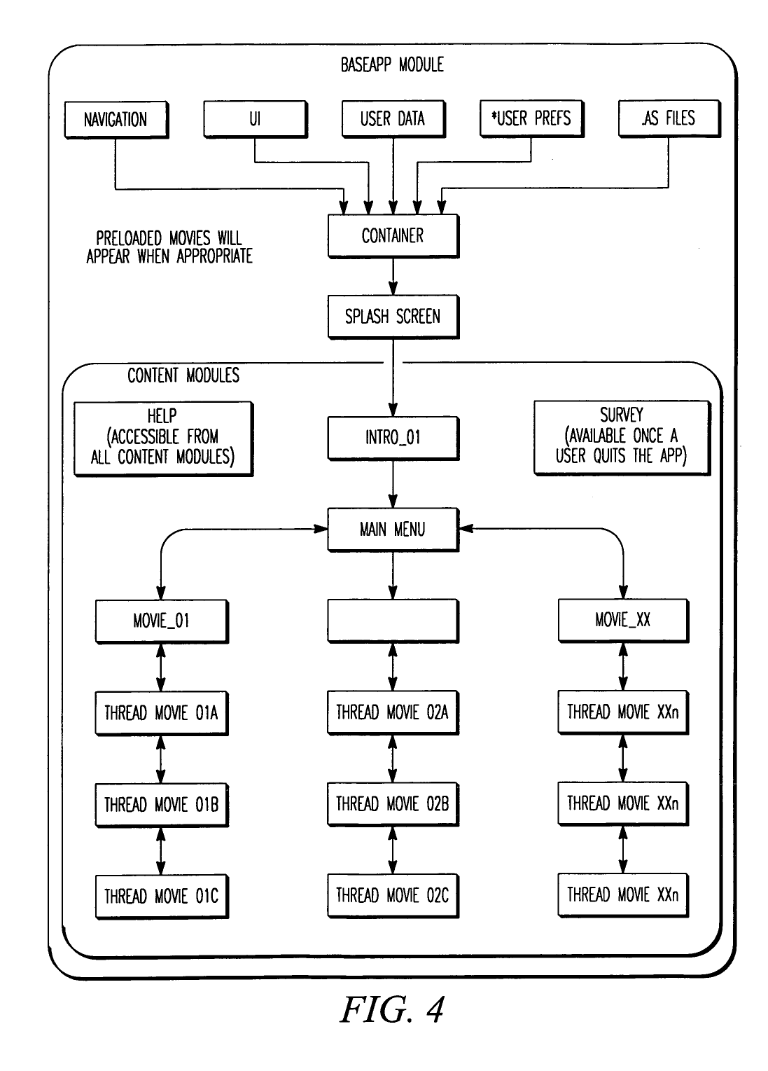

One flow diagram for an application module is illustrated in FIG. 4. The application module includes files for splash screens, preloader, introduction, threads, location-based visual menus, ActionScript files and maps. The splash screen is the first screen a user sees when using embodiments of the device. The preloader file offers several versions of a pre-loading screen to display while data is being transferred from a memory card. The introduction may be different from museum to museum. More generally, the introduction screen is different for each module. Thus, the application module provides for multiple modules and multiple threads. The module may include multiple threads per main movie content.

The ActionScript includes files in the baseApp module that are used as a central location to track all of the application code. A “desc” portion of the file name specifies what types of ActionScript code are contained in the file.

Preloader movies are used to hide any delay in the loading or unloading of movies in the application. For some embodiments, more than one preloader movie is created. For some embodiments, the preloader files are randomly loaded instead of being specified within the files. With this embodiment, users experience different preloaders in the application each time they use it.

BaseApp modules include a Splash Screen and one or more user preference screens. In one embodiment, a series of three numbered screens allow a user to customize his or her learning experience based upon their preferences. The user is able to select language that they prefer, the appearance of the applications and the type of content. For some embodiments, content may be selected to be directed to an adult or to a child.

Content modules include a Help screen with both narration and animation to assist the user in determining a solution. Help is available from every screen in the application except for the splash screen.

Content modules also include one or more survey screens. The survey screen queries users concerning whether they wish to quit and whether they would mind taking a survey. If the user agrees to take the survey, he or she is taken to one or more screens with questions. Answers to the questions are stored locally as variables in the user data tracking menu and, for some embodiments, are written out as XML values.

Content modules also include a Main Menu screen. The main menu screen acts as a multipurpose screen and serves as a main menu and as a location reference. As a main menu, users select a room in a museum from a map and then use the main menu to select an art work. For some embodiments, rooms of the museum have some unique type of visual reference such as colored walls, icons, pictures and so forth. When a user comes into a room, he or she should be able to identify the room that he or she is in by matching some type of icon or visual representation on the screen. The user selects the room having the feature on the icon. An image of the room zooms in and reveals different pieces of artwork. The user may activate, in some embodiments, click on, particular features within the room to view more information about the particular feature. Art work on the screen is identifiable with artwork in the room.

The Main Menu screen also informs the user as to what rooms he or she has already visited by a visual indicator. This location tracking is performed by storing and retrieving variables in the movie, rather than with any type of physical location tracking system, such as WiFi.

Another content module screen is a movie screen. For each individual art work, exhibit or specific item of interest , there is at least one movie associated with it. The movies include the baseApp content that includes narration, 3D animation, graphics and learning points.

One other content module screen includes one or more threads. For each movie, there is one or more interactive screens, or threads. The threads contain narration, animation, graphics and text in a manner that presents queries to the user about what was must mentioned in an exhibit movie or about a subject that the user learned previously. Providing some type of multiple choice or drag and drop functionality with feedback enhances the experience.

Another content module screen is an exit screen. The exit screen allows the user to exit the application so that he or she may experience a sense of completion or accomplishment. For some embodiments, the final screen that users see is a “thank you” screen.

One module embodiment is illustrated in a flowchart in FIG. 4. The flowchart shows a menu directing users to movie modules 1,2 and XX and an interactive threads menu. The interactive threads menu directs users to multiple threads.

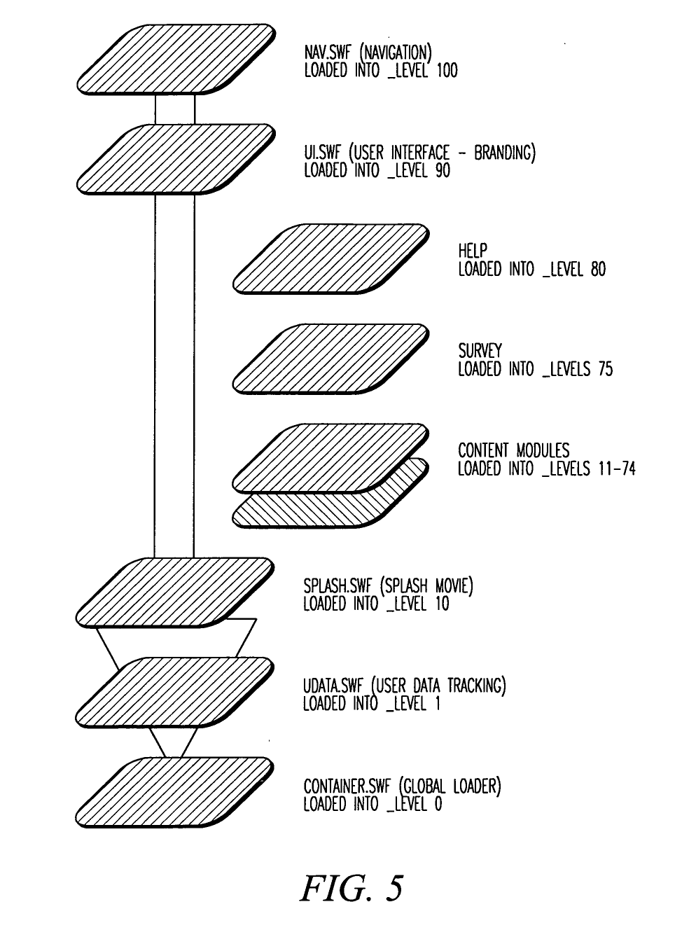

Device embodiments of the invention include FLASH to create content and applications that include only one movie for some embodiments and hundreds for other embodiments. Embodiments of the device include on baseApp module, a GUI, and content modules. The GUI includes a global loader, a user interface, navigation, a splash screen and user data tracking. For some embodiments, the splash screen is a movie. The movies or screens are organized as schematically shown in FIG. 5. The first movie or page that is loaded is the container. The container acts as the master movie and loads all external .as files into _level0, that contain all global ActionScript functions. By compartmentalizing all of the AS code into external .as files, functionality is further separated from content. Because all of the functions are loaded into _level0, the functions are accessible from all other movies in any level. Subsequent movies are loaded into levels above the first movie in an order which allows for easily adding content module movies in-between the different baseApp module movies. The “container.swf” file loads in the subsequent application swf files so that the same application may be run on both a Pocket PC and in a web browser.

Navigation of the device of the invention described herein includes global UI controls, movie controls and other controls. The global UI controls include a main menu that displays, in one embodiment, a map of a museum indicating the current room the user is in and what rooms have been visited by users. The Global UI also includes volume control and one or more help screens. The Global UI also includes movie controls that play or pause a movie; a rewind feature; a “back” feature that allows the user to display a previous screen, a “next” feature that allows the user to display the next screen, a “done” feature that displays the previous screen in the hierarchy and a progress bar which is animated that visually shows the remaining duration of the movie. The Global UI also includes other controls such as a “skip” control, a “choice” control, a “continue” control, a “cancel control and an “accept” control. Some global UI controls also include help screens. Embodiments of the device may contain fewer than all of the features described herein.

All navigation controls are located in one SWF file. This SWF file resides on top of other content. By locating all of the global and custom navigation into one SWF file, the process of making changes and adding content is easier to perform. In one embodiment, navigation controls include icons that are readily understood by children. For other embodiments, navigation controls are designed for adult use. Other features that have content dependent upon whether the user is a child or an adult include user interface, use of animated characters, dialog of narration and types of interactivity.

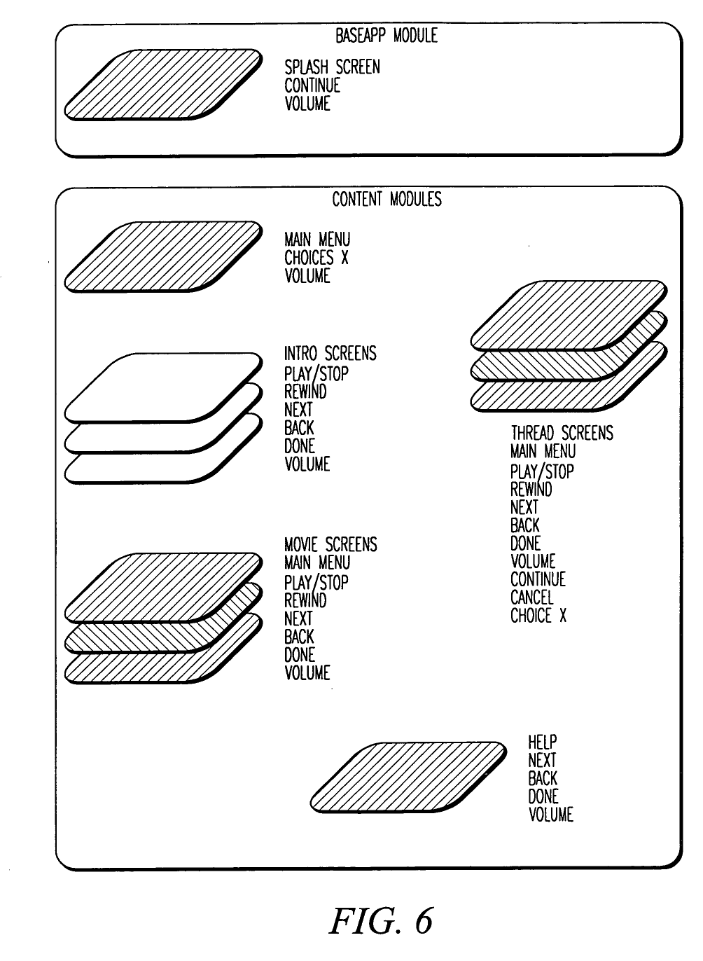

For some device embodiments, movie progress is monitored with features such as a simple time counter, an animated progress bar and an animated pie chart. For some embodiments, the device includes a way to linearly scroll through a movie. Similar to a fast forward or rewind function, the user has finite control of the content to the user. One embodiment includes a progress bar with a “handle” that the user drags across the progress bar to control the movie playback. One example of a navigation schema is shown in FIG. 6. Navigation functionality for the splash screen, a Base App module, included “Continue” and “Volume.” The Main Menu functionality included “Choices” and “Volume.” The Intro Screens included “Play/Stop,” “Rewind,” “Next” “Back,” “Done,” and “Volume.” The Movie Screen functionality included “Main Menu,” “Play/Stop,” “Rewind,”, “Next,” “Back,” “Done,” and “Volume.” The Thread Screen navigation functionality included “Main Menu,” “Play/Stop” “Rewind” “Next,” “Back,” “Done,” “Volume,” “Continue,” “Cancel,” and “Choice.” The help navigation functionality includes “Next,” “Back,” “Done,” and “Volume.” Input into embodiments of the device of the invention include stylus, hardware buttons and fingers. In one embodiment, a pocket PC is used to make a device embodiment of the invention by utilizing the launch hardware buttons which are mapped to specific applications on the device in addition to a 5-way digital pad. Because pocket PC's have touch screens it is possible to design an application which allows users to physically touch the pocket PC screen to interact with content, which allows for a more interactive and hands-on approach to an application. FLASH is usable for creating applications which allow for this type of interaction and was used in accordance to these rules: make all hotspots larger than the visual button. Ensure that the placement of buttons is accessible by users while holding the pocket PC. Reuse button objects when possible to help reduce the file size.

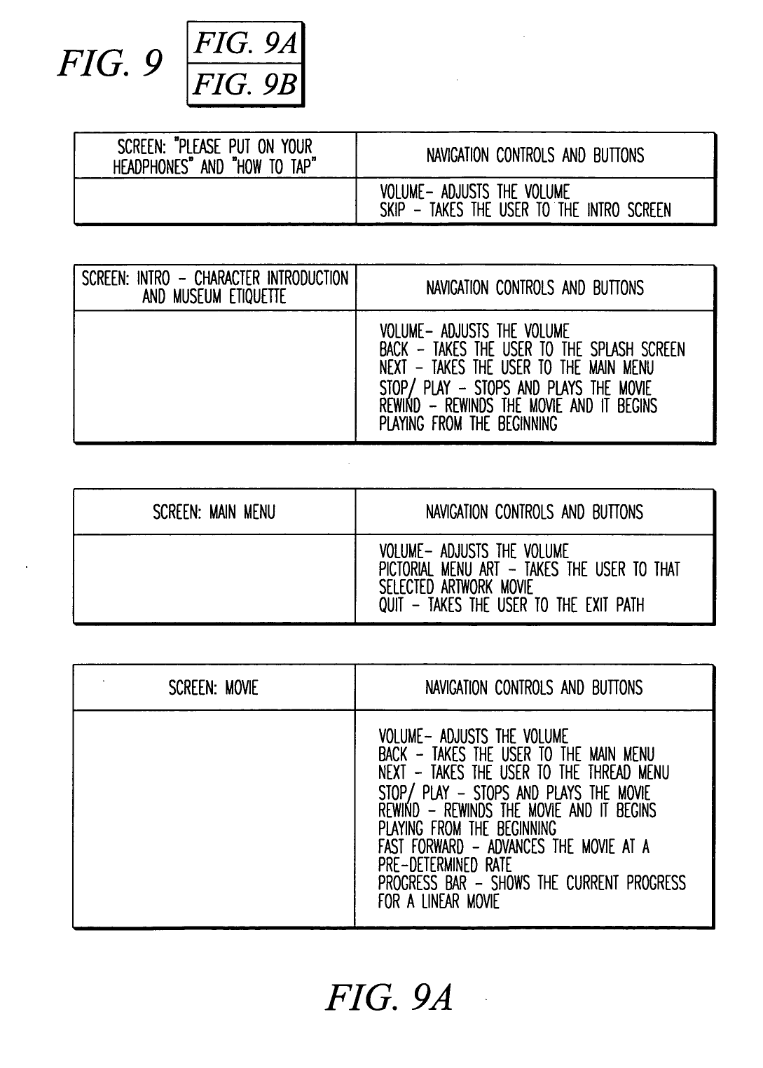

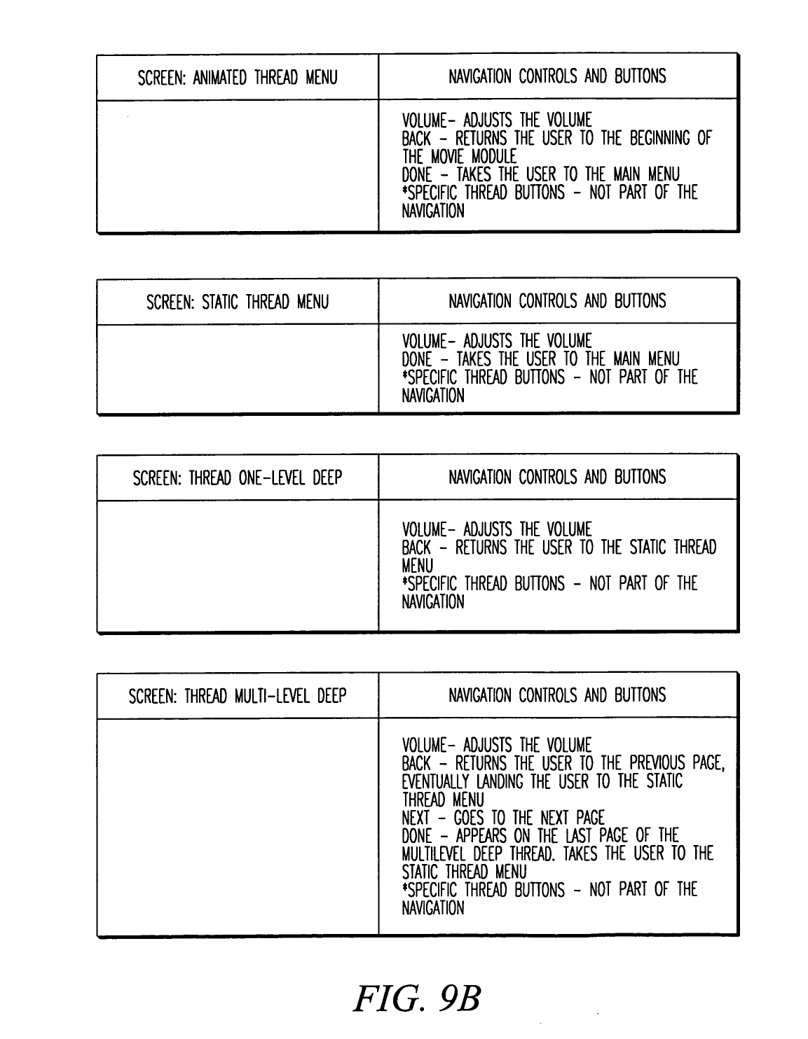

Examples of screens for display on embodiments of the device are listed in FIG. 9. One screen imparts a message, “Please put on your headphones” and, “How to tap.” A “Volume” button adjusts the volume and a “Skip” button takes the user to the intro screen. An introduction screen displays introduces a character and museum etiquette. The navigation controls and buttons usable for this screen include “Volume,” “Back,” “Next,” “Stop/Play,” and “Rewind.” Another screen is a main menu screen. Navigation controls and buttons include volume, a pictorial menu art that takes the user to a selected artwork movie and a quit control or button. Another screen is a movie screen and navigation controls and buttons for this screen include “Volume,” “Back,” “Next,” “Stop/Play,” “Rewind,” “Fast Forward” and a progress bar showing the current progress for a linear movie.

One other screen is an animated thread menu. The animated thread menu has navigation controls and buttons for “Volume,” “Back,” “Done” and specific thread buttons which are not part of the navigation. Another screen is a static thread menu that includes navigation controls and buttons for volume, done, and specific thread buttons. Another screen is a thread one level deep screen. This type of screen includes navigation controls and buttons for volume, back, and specific thread buttons. One other screen is a thread multi-level deep. This type of screen includes navigation controls and buttons for volume, back, next, done and specific thread buttons.

Some device embodiments include a user customization feature. Features that lend themselves to customization include color variation such as standard colors, bright primary colors, neutral colors, dark colors, cheerful colors, museum colors and blue colors. One other user customization is the language of the content.

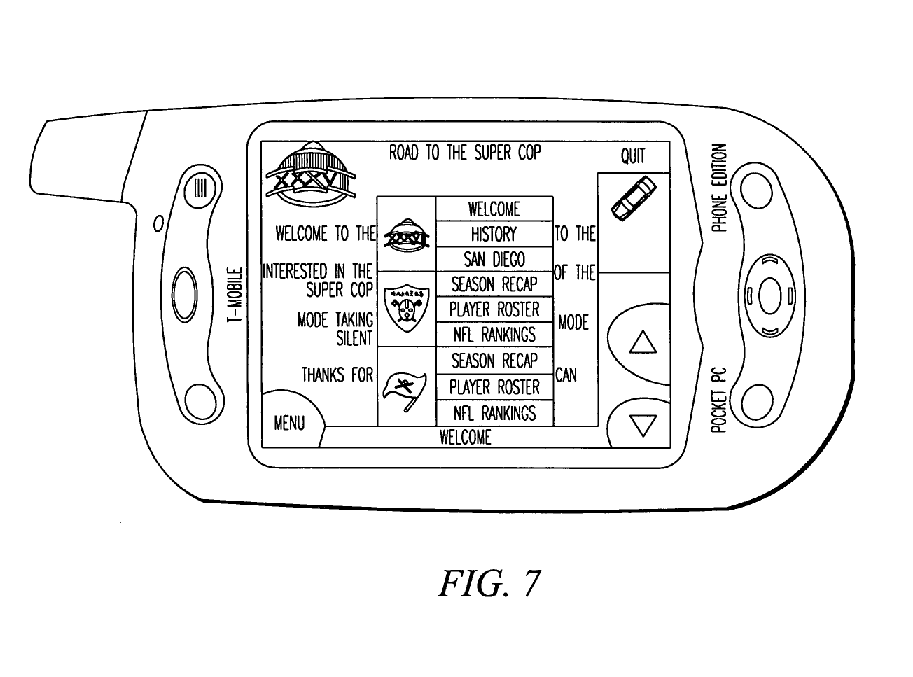

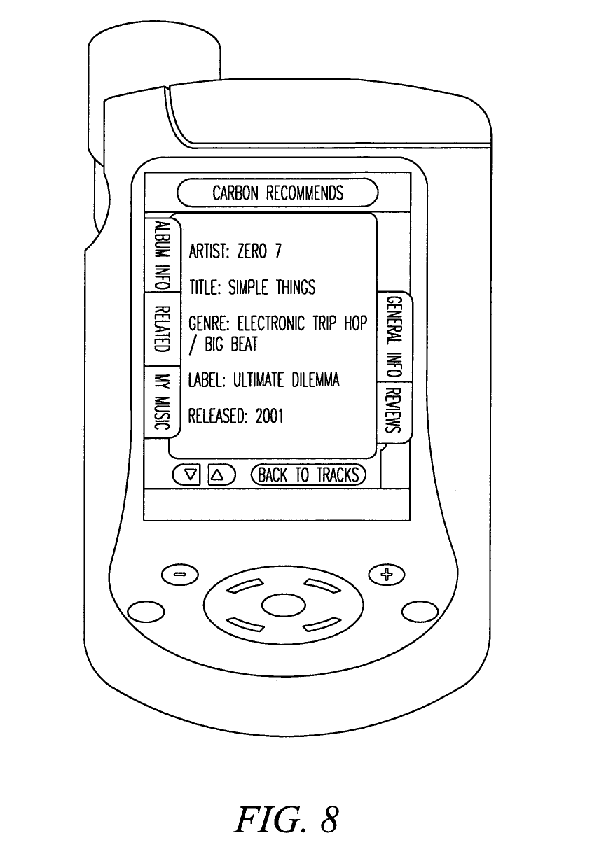

Memory for embodiments of the device include internal RAM and expansion options such as SD or CF. One pocket PC model usable in embodiments of the invention include the Dell Axim X30 model. The Dell X30 model includes a 624 MHz processor, build in SD slot, Blutooth and WiFi connectivity and other standard Pocket PC features. One embodiment of the Dell X30 pocket PC containing the baseAPP and content of the invention is shown in FIG. 7. One other embodiment of the device of the invention is shown in FIG. 8. While specific personal computer embodiments are described herein, it is understood that other embodiments are suitable for use in interactive educational device embodiments.

For some embodiments, the baseApp folder is placed directly on a handheld PC's ROM and the content folder is placed onto a memory card. The directory structure includes a module folder. The module folder includes these elements: audio for holding audio files; comp for holding composites; fileusemame; imagesource; 3Ddirectories, and refOut which include miscellaneous reference files provided from other sources.

Some device embodiments include features that collect data such as user feedback, exhibit tracking, application tracking, and duration of use. This data is collected in an XML file.

Embodiments that include location based applications permit users to move through complex surroundings such as museums, airports and other buildings enclosing large spaces. In one embodiment, a museum visitor checks out a device embodiment of the invention that contains all types of supplemental material for every piece of artwork in a museum and a layout of the museum. The device enables the user to walk through the museum and as the user approaches a piece of art work, narration and visuals are automatically presented to the user on the screen of the device.

For some embodiments, location is determined manually by entering a numeric value into the device and using a bar code scanner to scan a bar code, or aiming an infrared port on the device at an infrared transmitter. WiFi and global positioning (GPS) mechanisms are also useful to characterize and determine location. A mechanism such as WiFi is also useful to extract data from devices, send and receive information from a server and track when devices are checked in and out of a place such as a museum.

While the invention has been particularly shown and described with reference to particular embodiments, it is understood by those skilled in the art that various alterations and modifications in form and in detail may be made therein. Variations in the disclosed processor configuration will be readily apparent to those skilled in the art. Accordingly, it is intended that the following claims cover all such alterations and modifications as may fall within the spirit and scope of the invention.

What is claimed is:

1. An interactive device for providing information about one or more articles in a museum, gallery or zoo, comprising:
a main body comprising a screen,
computer readable medium comprising an application module that includes a global loader, a user interface, navigation and optionally, a splash screen and user data tracking; and, one or more content modules;
mechanism for projecting sound;
mechanism for playing content; and
mechanism for organizing content, wherein the content is related to the one or more articles in the museum, gallery or zoo, capable of being proximal to the device.

2. The interactive device of claim 1 wherein the content includes video images and audio content directed to the one or more articles in the museum, gallery or zoo, capable of being proximal to the device.

3. The interactive device of claim 2 wherein the one or more articles is in a single museum or art gallery.

4. The interactive device of claim 1 wherein the content regarding the one or more articles is stored on a DVD.

5. The interactive device of claim 1 wherein the content regarding the one or more articles is downloadable from the World Wide Web.

6. The interactive device of claim 1 wherein the content includes one or more movie modules related to the one or more articles.

7. The interactive device of claim 1 wherein the content includes one or more menus that correspond to a layout of one or more articles in the museum or gallery or zoo.

8. The interactive device of claim 1 wherein the content includes questions and answers related to the one or more articles.

9. The interactive device of claim 1 wherein one or more of the articles is a painting.

10. The interactive device of claim 1 wherein one or more of the articles is a museum exhibit.

11. An interactive device for providing information about one or more articles in a museum, gallery or zoo, comprising:
a main body comprising a screen,
tactile sensitive mechanisms for changing images on the screen;
a mechanism for projecting sound;
content comprising movies, screens, interactive queries and surveys related to an article proximal to the interactive device;
a mechanism for playing content; and
a storage mechanism for storing content, wherein the content is related to an article capable of being proximal to the device.

12. The interactive device of claim 11 wherein the content is related to paintings in one or more museums.

13. A method for obtaining information about an article proximal to a user, comprising:
obtaining the device of claim 1;
downloading content related to the article into the device; and
reviewing content while positioned in proximity with the article.

14. Computer readable medium for use with a portable device, comprising: a basic application and content related to an article proximal to the device.

15. A system for learning about art, comprising:
a computer and content on media readable by the computer directed to teaching one or more of principles, elements, foundations and concepts of art; and
the interactive device of claim 1 that includes content in computer readable form for providing information related to understanding the artwork while being proximal to it.

16. The system of claim 15, further comprising content readable by the computer directed to enabling a user to create art.

17. The system of claim 15 wherein the content is multimedia content.

18. The system of claim 15 wherein the content is streaming video.
